(19) United States
(12) Patent Application Publication
(10) Pub. No.: US 2006/0105908 A1
(43) Pub. Date: May 18, 2006

(54) Catalyst for purifying exhaust gases and process for producing the same

(75) Inventors: Yoshiharu Miyake, Nishikamo-gun (JP); Shingo Sakagami, Kakegawa-shi (JP)

Correspondence Address: OLIFF & BERRIDGE, PLC, P.O. BOX 19928, ALEXANDRIA, VA, 22320, US

(73) Assignees: TOYOTA JIDOSHA KABUSHIKI KAISHA, AICHI (JP); CATELER CORPORATION, OGASA (JP)

(21) Appl. No.: 10/545,068

(22) PCT Filed: Feb. 9, 2004
(86) PCT No.: PCT/JP04/01350

§ 371 Date: Oct. 28, 2005

(30) Foreign Application Priority Data
Feb. 12, 2003 (JP) 2003-033842

(51) Int. Cl. B01J 23/10

(52) U.S. Cl. 502/304; 502/325

(57) ABSTRACT

With respect to an oxide powder having a characteristic that a suspension suspending the oxide powder in pure water exhibits a pH value of 7 or less, a noble metal is loaded on the oxide powder by using a noble metal salt solution exhibiting a pH value lower than the pH value of the suspension in order to inhibit the granular growth of loaded noble metal particles at high temperatures. It is believed that the affinity enlarges between noble metal particles, generated by the decomposition of the noble metal salt, and the oxide powder because no coarse noble metal particles are generated by neutralizing the noble metal salt so that the binding force enlarges between the oxide powder and the noble metal salt.

### TECHNICAL FIELD

The present invention relates to a catalyst for purifying exhaust gases of internal combustion engines for automobiles and the like, and a process for producing the same.

### BACKGROUND ART

A catalyst (three-way catalyst) for purifying exhaust gases comprises, for example, a support substrate composed of heat-resistant ceramics, such as cordierite, a catalyst loading layer formed on this support substrate and composed of activated alumina and the like, and a noble metal, such as Pt, loaded on this catalyst loading layer. This three-way catalyst purifies hydrocarbons (HC) and carbon monoxide (CO) by oxidation, and purifies nitrogen oxides (NOₓ) by reduction.

However, since the oxygen concentration in exhaust gases fluctuates greatly depending on running conditions and the like, there might arise instances where the purifying activity of oxidation and reduction becomes unstable in three-way catalysts. Hence, it has been carried out adding CeO₂ to the catalyst loading layer. CeO₂ has an oxygen storage-and-release ability (hereinafter referred to as “OSC”) by which it stores oxygen in oxidizing atmospheres and releases oxygen in reducing atmospheres, and thereby it is possible to obtain a stable purifying activity even when the oxygen concentration in exhaust gases fluctuates.

Moreover, three-way catalysts including CeO₂ are such that the OSC is likely to be lowered by the crystalline growth of CeO₂ and the granular growth of noble metal accompanied therewith when they are used at high temperatures of 800° C. or more. Accordingly, in order to maintain a high OSC by inhibiting the crystalline growth of CeO₂, it has been carried out using CeO₂—ZrO₂ system composite oxides.

For example, in Japanese Unexamined Patent Publication (KOKAI) No. 2000-176,282, a catalyst is disclosed which comprises a CeO₂—ZrO₂ solid solution, whose proportion of Ce to Zr is fallen in a specific range, a porous substance such as Al₂O₃, the CeO₂—ZrO₂ solid solution and porous substance used as a support, and a noble metal loaded on one of them at least. In accordance with this catalyst, it is possible to inhibit the OSC from lowering, and the sulfur-poisoning resistance is improved.

Moreover, in Japanese Patent Publication No. 2,659,796, a catalyst is disclosed which comprises a CeO₂—ZrO₂ system composite oxide, a heat-resistant inorganic oxide, such as Al₂O₃, and a noble metal, and there is set forth that the durability is improved and high purifying performance is revealed.

However, due to the recent improvements of engine performance and being accompanied by the increment of high-speed driving, the temperature of exhaust gases has been increased sharply. Accordingly, the temperature of catalysts for purifying exhaust gases has rose remarkably as well in service, compared with that of conventional ones, and consequently it has become difficult to inhibit the granular growth of noble metal even when the solid solution of CeO₂—ZrO₂ system composite oxides is used.

### DISCLOSURE OF INVENTION

The present invention has been done in view of such circumstances, and accordingly its object is to further inhibit the granular growth of noble metal at high temperatures.

A feature of a catalyst according to the present invention for purifying exhaust gases, catalyst set forth in claim 1 which solves the aforementioned problem, lies in that it comprises: an oxide powder having a characteristic that a suspension suspending the oxide powder in pure water exhibits a pH value of 7 or less; and a noble metal loaded on the oxide powder by using a noble metal salt solution exhibiting a pH value lower than the pH value of the suspension suspending the oxide powder in pure water.

Moreover, a feature of a process according to the present invention for producing a catalyst for purifying exhaust gases lies in that it comprises the steps of: preparing an oxide powder having a characteristic that a suspension suspending the oxide powder in pure water exhibits a pH value of 7 or less; and loading a noble metal on the oxide powder by using a noble metal salt solution exhibiting a pH value lower than the pH value of the suspension suspending the oxide powder in pure water.

In the present catalyst for purifying exhaust gases and process for producing the same, it is preferable that the oxide powder can be a CeO₂-based oxide including CeO₂ at least, and it is desirable that the oxide powder can include at least one element selected from the group consisting of Zr, La, Y and Nd.

Moreover, it is preferable that the noble metal salt solution can be a Pt salt aqueous solution, and it is desirable that a difference (ΔpH) between the pH value of the suspension suspending the oxide powder in pure water and the pH value of the noble metal salt solution can be from 1 to 5.

### BRIEF DESCRIPTION OF THE DRAWING

FIG. 1 is a graph for illustrating the relationship between the pH value of suspensions used in examples, suspensions which suspended composite oxides in pure water, and the CO 50% conversion temperature.

### BEST MODE FOR CARRYING OUT THE INVENTION

The mechanism how noble metal particles loaded on supports grow granularly is believed to result mainly from the evaporation and re-precipitation of noble metal particles at high temperatures. Therefore, in order to inhibit the granular growth, it is believed to be effective to strengthen the electronic interaction between noble metal particles and supports, or to inhibit the evaporation by modifying and the like the surface of noble metal particles.

On the other hand, in the conventional methods of loading noble metals, noble metals are loaded on supports in liquid phases by adsorbing noble metal salts to the supports or impregnating supports with noble metal salts and thereafter by decomposing the noble metal salts by means of heat treatments. However, in the methods, since the affinity (chemical bonding force) is less between noble metal particles, generated by the decomposition, and supports, it is difficult to inhibit the granular growth of noble metal particles at high temperatures.

Hence, in the present process for producing a catalyst for purifying exhaust gases, with respect to an oxide powder having a characteristic that a suspension suspending the oxide powder in pure water exhibits a pH value of 7 or less, a noble metal salt solution exhibiting a pH value lower than the pH value of the suspension is used. When an oxide powder whose suspension exhibits a pH value of 7 or less is used, since noble metal salts are not neutralized while loading noble metal salts, no coarse noble metal particles are generated in aqueous solutions. And, when a noble metal salt solution exhibiting a pH value lower than the pH value of the suspension is used, it is believed that the affinity between noble metal particles, generated by the decomposition of the noble metal salt, and the oxide powder enlarges.

Therefore, in accordance with the present production process, since fine noble metal particles can be loaded, and additionally the affinity between the oxide powder and the noble metal particles is strengthened, it is believed that not only the noble metal particles are inhibited from moving at high temperatures but also the noble metal particles are inhibited from evaporating.

When the pH value of the suspension suspending the oxide powder in pure water exceeds 7, since the noble metal salt is neutralized while loading the noble metal salt, coarse noble metal particles are generated in aqueous solutions, and they are loaded on the oxide powder. When such coarse particles exist, there arises a problem that not only the catalytic activity has lowered but also the granular growth at high temperatures has been further facilitated.

Moreover, when the pH value of the noble metal salt solution is the pH value of the suspension or more, the bonding force between the oxide powder and the noble metal salt is weak. Accordingly, the affinity between noble metal particles, generated by decomposing the noble metal salt, and the oxide powder has been weakened so that the granular growth has occurred at high temperatures to coarsen and lower the catalytic activity greatly.

As for the oxide powder having a characteristic that a suspension suspending the oxide powder in pure water exhibits a pH value of 7 or less, it is possible to use CeO₂-based oxides, which are produced by a co-precipitation method, for example. In accordance with the co-precipitation method, it is possible to make the pH value of the suspension 7 or less with ease by controlling the calcination conditions (temperature, time, temperature increment rate and atmosphere) of the precipitates of generated oxide precursors.

Moreover, when the pH value of the suspension exceeds 7, it is possible to make the pH value 7 or less by modifying the superficial quality or state by means of a pretreatment. As for the pretreatment, there is a method of treating the oxide powder with acids. For example, after the oxide powder is immersed in an acid aqueous solution of nitric acid, acetic acid, hydrochloric acid and the like, it is possible to make the pH value 7 or less by filtering, washing and drying it and followed by calcining it at 250-500° C. for 2-12 hours. In this instance, as for the acid, those which do not reside after the treatment are preferable, and those which do not include the S element and the Cl element are desirable.

In addition, as for the pretreatment, there is a method of exposing the oxide powder to a gas including CO₂. In this instance, the CO₂ concentration in the gas can be an equal mol or more to the oxide powder to be treated.

The noble metal salt solution is such that it is possible to use those which exhibit a pH value lower than the pH value of the suspension. As for the noble metal, Pt, Rh, Pd, Ir and the like can be exemplified, and, as for the salt, there are ammine nitrates, nitrates, hydrochlorides, acetates, and so forth. The present invention is especially effective in the case where Pt salt aqueous solutions are used.

Moreover, it is desirable that the difference (ΔpH) between the pH value of the suspension and the pH value of the noble metal salt solution can be from 1 to 5. When the ΔpH is fallen in this range, it is possible to further inhibit the granular growth of noble metals. For example, when the pH value of the noble metal salt solution is from 2 to 3, the pH value of the suspension can be adjusted so as to be from 4 to 7. In addition, the ΔpH is such that a range of from 1 to 3 is especially desirable.

When loading the noble metal on the oxide powder, it can be carried out by impregnating a predetermined amount of the oxide powder with a predetermined amount of the noble metal salt aqueous solution and drying and calcining it. Moreover, it can be loaded by forming a coating layer of the oxide powder on the surface of honeycomb substrates, impregnating it with the noble metal salt aqueous solution, and followed by drying and calcining it.

As for the oxide powder, those whose suspension exhibits a pH value of 7 or less can be used, can be selected from Al₂O₃, CeO₂, ZrO₂, CeO₂—ZrO₂, TiO₂ and the like, but can preferably be a CeO₂-based oxide including CeO₂ at least. This is because CeO₂-based oxides are such that it is possible to make the pH value of the suspension 7 or less with ease by producing them by means of the co-precipitation method as set forth above. Moreover, this is because noble metals loaded on CeO₂ are much less likely to cause the granular growth compared with the case where they are loaded on the other oxides so that it is possible to further inhibit the granular growth.

As for the CeO₂-based oxide, it is desirable to include at least one element selected from the group consisting of Zr, La, Y and Nd. When these elements are added, it is possible to inhibit the granular growth of CeO₂ at high temperatures, and accordingly it is possible to further inhibit the granular growth of the loaded noble metal. Note that the addition amount of these elements is such that, by molar ratio, Zr can desirably be in a range of Zr/Ce=0.1-10 with respect to Ce; La can desirably be in a range of La/Ce=0.01-5 with respect to Ce; Y can desirably be in a range of Y/Ce=0.01-5 with respect to Ce; and Nd can desirably be in a range of Nd/Ce=0.01-5 with respect to Ce.

Namely, in accordance with the present catalyst for purifying exhaust gases, since it is possible to inhibit the granular growth of loaded noble metals, the durability of purifying activities is improved greatly. Moreover, in accordance with the present production process, it is possible to produce the present catalyst for purifying exhaust gases easily and securely.

### EXAMPLES

Hereinafter, the present invention will be described in detail with reference to examples and comparative examples.

### Example No. 1

50 parts by weight of cerium nitrate and 50 parts by weight of zirconium oxynitrate were solved in pure water to prepare a mixture aqueous solution, while stirring it, ammonia water was added in an equivalent weight or more for neutralizing the nitrate ions to generate precipitates. They were washed and filtered, were dried in air at 250° C. for 4 hours, and were thereafter calcined at 700° C. for 2 hours, thereby preparing a CeO₂—ZrO₂ composite oxide powder. When this CeO₂—ZrO₂ composite oxide powder was suspended in pure water, the pH value of the suspension was 6.8.

This CeO₂—ZrO₂ composite oxide powder was impregnated with a predetermined amount of a Pt(NO₂)₂(NH₃)₂ aqueous solution, after drying and evaporating it, was calcined at 250° C. for 4 hours, thereby preparing a catalyst powder. The pH value of the Pt(NO₂)₂(NH₃)₂ aqueous solution was 2.2, and the loading amount of Pt was 1.0% by weight.

This catalyst powder was pelletized by an ordinary method, thereby making a pelletized catalyst.

### Example No. 2

Except that 65 parts by weight of cerium nitrate, 30 parts by weight of zirconium oxynitrate and 5 parts by weight of yttrium nitrate were used as starting raw materials, a CeO₂—ZrO₂—Y₂O₃ composite oxide powder was prepared in the same manner as Example No. 1. When this CeO₂—ZrO₂—Y₂O₃ composite oxide powder was suspended in pure water, the pH value of the suspension was 5.7.

Except that this composite oxide powder was used, Pt was loaded in the same manner as Example No. 1, thereby making a pelletized catalyst similarly. The pH value of the Pt(NO₂)₂(NH₃)₂ aqueous solution was 2.2.

### Example No. 3

Except that 60 parts by weight of cerium nitrate, 35 parts by weight of zirconium oxynitrate and 5 parts by weight of lanthanum nitrate were used as starting raw materials, a CeO₂—ZrO₂—La₂O₃ composite oxide powder was prepared in the same manner as Example No. 1. When this CeO₂—ZrO₂—La₂O₃ composite oxide powder was suspended in pure water, the pH value of the suspension was 5.6.

Except that this composite oxide powder was used, Pt was loaded in the same manner as Example No. 1, thereby making a pelletized catalyst similarly. The pH value of the used Pt(NO₂)₂(NH₃)₂ aqueous solution was 2.2.

### Example No. 4

Except that 60 parts by weight of cerium nitrate, 35 parts by weight of zirconium oxynitrate and 5 parts by weight of lanthanum nitrate were used as starting raw materials, a CeO₂—ZrO₂—La₂O₃ composite oxide powder was prepared in the same manner as Example No. 1. When this CeO₂—ZrO₂—La₂O₃ composite oxide powder was suspended in pure water, the pH value of the suspension was 4.8.

Except that this composite oxide powder was used, Pt was loaded in the same manner as Example No. 1, thereby making a pelletized catalyst similarly. The pH value of the used Pt (NO₂)₂(NH₃)₂ aqueous solution was 2.2.

### Example No. 5

Except that 60 parts by weight of cerium nitrate, 35 parts by weight of zirconium oxynitrate and 5 parts by weight of lanthanum nitrate were used as starting raw materials, a CeO₂—ZrO₂—La₂O₃ composite oxide powder was prepared in the same manner as Example No. 1. When this CeO₂—ZrO₂—La₂O₃ composite oxide powder was suspended in pure water, the pH value of the suspension was 4.8.

Except that this composite oxide powder was used, Pt was loaded in the same manner as Example No. 1, thereby making a pelletized catalyst similarly. The pH value of the used Pt (NO₂)₂(NH₃)₂ aqueous solution was 3.4.

### Example No. 6

Except that 50 parts by weight of cerium nitrate, 45 parts by weight of zirconium oxynitrate and 5 parts by weight of lanthanum nitrate were used as starting raw materials, a CeO₂—ZrO₂—La₂O₃ composite oxide powder was prepared in the same manner as Example No. 1. When this CeO₂—ZrO₂—La₂O₃ composite oxide powder was suspended in pure water, the pH value of the suspension was 6.0.

Except that this composite oxide powder was used, Pt was loaded in the same manner as Example No. 1, thereby making a pelletized catalyst similarly. The pH value of the used Pt (NO₂)₂(NH₃)₂ aqueous solution was 2.2.

### Example No. 7

Except that 60 parts by weight of cerium nitrate, 35 parts by weight of zirconium oxynitrate and 5 parts by weight of neodymium nitrate were used as starting raw materials, a CeO₂—ZrO₂—Nd₂O₃ composite oxide powder was prepared in the same manner as Example No. 1. When this CeO₂—ZrO₂—Nd₂O₃ composite oxide powder was suspended in pure water, the pH value of the suspension was 5.9.

Except that this composite oxide powder was used, Pt was loaded in the same manner as Example No. 1, thereby making a pelletized catalyst similarly. The pH value of the used Pt (NO₂)₂(NH₃)₂ aqueous solution was 2.2.

### Comparative Example No. 1

Except that 65 parts by weight of cerium nitrate and 35 parts by weight of zirconium oxynitrate were used as starting raw materials, and that the calcining condition of the precipitates was changed, a CeO₂—ZrO₂ composite oxide powder was prepared in the same manner as Example No. 1. When this CeO₂—ZrO₂ composite oxide powder was suspended in pure water, the pH value of the suspension was 8.8.

Except that this composite oxide powder was used, Pt was loaded in the same manner as Example No. 1, thereby making a pelletized catalyst similarly. The pH value of the used Pt (NO₂)₂(NH₃)₂ aqueous solution was 2.2.

### Comparative Example No. 2

Except that 60 parts by weight of cerium nitrate, 35 parts by weight of zirconium oxynitrate and 5 parts by weight of lanthanum nitrate were used as starting raw materials, and that the aging condition of the precipitates was changed, a CeO₂—ZrO₂—La₂O₃ composite oxide powder was prepared in the same manner as Example No. 1. When this CeO₂—ZrO₂—La₂O₃ composite oxide powder was suspended in pure water, the pH value of the suspension was 8.2.

Except that this composite oxide powder was used, Pt was loaded in the same manner as Example No. 1, thereby making a pelletized catalyst similarly. The pH value of the used Pt (NO₂)₂(NH₃)₂ aqueous solution was 2.2.

### Comparative Example No. 3

Except that 60 parts by weight of cerium nitrate, 35 parts by weight of zirconium oxynitrate and 5 parts by weight of lanthanum nitrate were used as starting raw materials, and that the aging condition of the precipitates was changed, a CeO₂—ZrO₂—La₂O₃ composite oxide powder was prepared in the same manner as Example No. 1. When this CeO₂—ZrO₂—La₂O₃ composite oxide powder was suspended in pure water, the pH value of the suspension was 8.5.

Except that this composite oxide powder was used, Pt was loaded in the same manner as Example No. 1, thereby making a pelletized catalyst similarly. The pH value of the used Pt(NO₂)₂(NH₃)₂ aqueous solution was 2.2.

### Comparative Example No. 4

Except that 60 parts by weight of cerium nitrate, 35 parts by weight of zirconium oxynitrate and 5 parts by weight of lanthanum nitrate were used as starting raw materials, and that the aging condition of the precipitates was changed, a CeO₂—ZrO₂—La₂O₃ composite oxide powder was prepared in the same manner as Example No. 1. When this CeO₂—ZrO₂—La₂O₃ composite oxide powder was suspended in pure water, the pH value of the suspension was 8.5.

Except that this composite oxide powder was used, Pt was loaded in the same manner as Example No.1, thereby making a pelletized catalyst similarly. The pH value of the used Pt (NO₂)₂(NH₃)₂ aqueous solution was 3.4.

### Example No. 8

The CeO₂—ZrO₂—La₂O₃ composite oxide powder (the pH value of the suspension=8.2) prepared in Comparative Example No. 2 was used, was immersed in a nitric acid aqueous solution whose pH value=2 for 2 hours. It was filtered and washed, was dried at 250° C. for 4 hours, and was thereafter calcined at 500° C. for 2 hours. The pH value of a suspension suspending the resulting pretreated CeO₂—ZrO₂—La₂O₃ composite oxide powder was 4.4.

Except that this composite oxide powder was used, Pt was loaded in the same manner as Example No.1, thereby making a pelletized catalyst similarly. The pH value of the used Pt(NO₂)₂(NH₃)₂ aqueous solution was 2.2.

### Example No. 9

The CeO₂—ZrO₂—La₂O₃ composite oxide powder (the pH value of the suspension=8.2) prepared in Comparative Example No. 2 was used, was immersed in an acetic acid aqueous solution whose pH value=2 for 2 hours. It was filtered and washed, was dried at 250° C. for 4 hours, and was thereafter calcined at 500° C. for 2 hours. The pH value of a suspension suspending the resulting pretreated CeO₂—ZrO₂—La₂O₃ composite oxide powder was 5.3.

Except that this composite oxide powder was used, Pt was loaded in the same manner as Example No. 1, thereby making a pelletized catalyst similarly. The pH value of the used Pt(NO₂)₂(NH₃)₂ aqueous solution was 2.2.

### Example No. 10

The CeO₂—ZrO₂—La₂O₃ composite oxide powder (the pH value of the suspension=8.2) prepared in Comparative Example No. 2 was used, was immersed in a hydrochloric acid aqueous solution whose pH value=2 for 2 hours. It was filtered and washed, was dried at 250° C. for 4 hours, and was thereafter calcined at 500° C. for 2 hours. The pH value of a suspension suspending the resulting pretreated CeO₂—ZrO₂—La₂O₃ composite oxide powder was 4.3.

Except that this composite oxide powder was used, Pt was loaded in the same manner as Example No. 1, thereby making a pelletized catalyst similarly. The pH value of the used Pt(NO₂)₂(NH₃)₂ aqueous solution was 2.2.

### Example No. 11

The CeO₂—ZrO₂—La₂O₃ composite oxide powder (the pH value of the suspension=8. 2) prepared in Comparative Example No. 2 was used, an N₂ gas including 1% CO₂ was distributed for 5 hours. The pH value of a suspension suspending the resulting pretreated CeO₂—ZrO₂—La₂O₃ composite oxide powder was 6.0.

Except that this composite oxide powder was used, Pt was loaded in the same manner as Example No. 1, thereby making a pelletized catalyst similarly. The pH value of the used Pt(NO₂)₂(NH₃)₂ aqueous solution was 2.2.

### Example No. 12

The CeO₂—ZrO₂—La₂O₃ composite oxide powder (the pH value of the suspension=8.2) prepared in Comparative Example No. 2 was used, an N₂ gas including 1% CO₂ was distributed for 5 hours. The pH value of a suspension suspending the resulting pretreated CeO₂—ZrO₂—La₂O₃ composite oxide powder was 6.0.

Except that this composite oxide powder was used, Pt was loaded in the same manner as Example No. 1, thereby making a pelletized catalyst similarly. The pH value of the used Pt(NO₂)₂(NH₃)₂ aqueous solution was 3.4.

### Comparative Example No. 5

The CeO₂—ZrO₂—La₂O₃ composite oxide powder (the pH value of the suspension=8.2) prepared in Comparative Example No. 2 was used, was immersed in ammonia water whose pH value=10 for 2 hours. It was filtered and washed, was dried at 250° C. for 4 hours, and was thereafter calcined at 500° C. for2 hours. The pH value of a suspension suspending the resulting pretreated CeO₂—ZrO₂—La₂O₃ composite oxide powder was 8.8.

Except that this composite oxide powder was used, Pt was loaded in the same manner as Example No. 1, thereby making a pelletized catalyst similarly. The pH value of the used Pt(NO₂)₂(NH₃)₂ aqueous solution was 2.2.

### TEST AND ASSESSMENT

The resulting respective pelletized catalysts were filled into an assessment apparatus, respectively, and a durability test was carried in which they were held at 1,000° C. for 5 hours while alternately flowing an N₂ gas including 2% CO and another N₂ gas including 5% O₂ for every 1 minute.

The Pt particle diameter of each of the catalysts after the durability test was measured by a CO pulse adsorption method, and ratios with respect to the Pt particle diameter of the catalyst of Example No. 5 are set forth in Table 2.

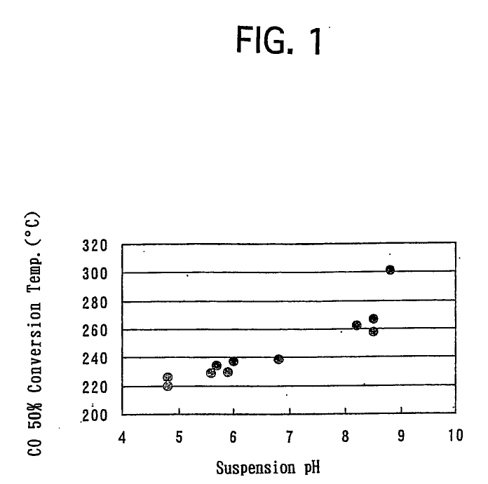

Moreover, each of the catalysts after the durability test was filled into an assessment apparatus, respectively, the temperature was increased from 3° C. to 500° C. while flowing a model gas set forth in Table 1, the CO conversions there between were measured with time. A CO 50% conversion temperature (CO50T), a temperature at which the CO conversion was 50%, was found from the resulting measured values, respectively, and the results are set forth in Table 2. In addition, the relationship between the pH values of the suspensions and the CO 50% conversion temperatures is illustrated in FIG. 1.

From Table 2, it is understood that the catalyst of each of the examples was such that the CO 50% conversion temperature was lower compared with the catalysts of the comparative examples, and that a high activity was maintained even after the durability test. And, since a close correlation is appreciable between the CO 50% conversion temperatures and the Pt particle diameter ratios, it is apparent that maintaining a high activity even after the durability test results from the fact that the granular growth of Pt was inhibited. Namely, in the catalyst of the examples, the granular growth of Pt was inhibited during the durability test, as a result, a high purifying activity was revealed even after the durability test.

And, since each of the examples was different from each of the comparative examples only in that the pH value of the used suspensions suspending the composite oxide powders was 7 or less, it is understood that the granular growth of Pt is inhibited by using those whose suspension exhibits a pH value of 7 or less and using noble metal salt aqueous solutions which exhibit a pH value lower than the pH value of the suspension. Moreover, from FIG. 1, it is seen that the lower the pH value of the suspension was the more the CO purifying activity was improved.

Moreover, in Table 2, there is recited the ΔpH, the difference between the pH value of the suspension and the pH value of the Pt salt aqueous solution, but it is apparent that the smaller ΔpH was the more the granular growth of Pt was inhibited, and the ΔpH fell in a range of from 1 to 5 in the examples.

In addition, it is apparent that it was possible to make the pH value of the suspension 7 or less by carrying out a pretreatment, such as the acid treatment, even when the composite oxide whose suspension exhibited a pH value exceeding 7 was used, and thereby the granular growth of Pt was inhibited and accordingly a high purifying activity was revealed even after the durability test.

TABLE 1

| | Gas | | | | | | |
|---|---|---|---|---|---|---|---|
| Species | CO₂ | O₂ | C₃H₆ | CO | NO | H₂O | N₂ |
| Concentration | 14.1 | 0.25 | 0.085 | 0.12 | 0.25 | 2 | Balance |
| (%) | | | | | | | |

TABLE 2

| | | | | | | Pt Particle |
|---|---|---|---|---|---|---|
| | | | Pt Salt | | CO50T | Dia. |
| | | | pH | Δ pH | (° C.) | Ratio |
| | Oxide Composition | Suspension | | | | |
| | (% by Weight) | pH | | | | |
| Ex. #1 | CeO₂/ZrO₂ = 50/50 | 6.8 | 2.2 | 4.6 | 239 | 1.6 |
| Ex. #2 | CeO₂/ZrO₂/Y₂O₃ = 65/30/5 | 5.7 | 2.2 | 3.5 | 234 | 1.5 |
| Ex. #3 | CeO₂/ZrO₂/La₂O₃ = 60/35/5 | 5.6 | 2.2 | 3.4 | 229 | 1.4 |
| Ex. #4 | CeO₂/ZrO₂/La₂O₃ = 60/35/5 | 4.8 | 2.2 | 2.6 | 226 | 1.2 |
| Ex. #5 | CeO₂/ZrO₂/La₂O₃ = 60/35/5 | 4.8 | 3.4 | 1.4 | 220 | 1.0 |
| Ex. #6 | CeO₂/ZrO₂/La₂O₃ = 50/45/5 | 6.0 | 2.2 | 3.8 | 237 | 1.5 |
| Ex. #7 | CeO₂/ZrO₂/Nd₂O₃ = 60/35/5 | 5.9 | 2.2 | 3.7 | 230 | 1.4 |
| Comp. | CeO₂/ZrO₂ = 65/35 | 8.8 | 2.2 | 6.6 | 301 | 4.3 |
| Ex. #1 | | | | | | |
| Comp. | CeO₂/ZrO₂/La₂O₃ = 60/35/5 | 8.2 | 2.2 | 6.0 | 262 | 2.9 |
| Ex. #2 | | | | | | |
| Comp. | CeO₂/ZrO₂/La₂O₃ = 60/35/5 | 8.5 | 2.2 | 6.3 | 267 | 3.2 |
| Ex. #3 | | | | | | |
| Comp. | CeO₂/ZrO₂/La₂O₃ = 60/35/5 | 8.5 | 3.4 | 5.1 | 258 | 2.8 |
| Ex. #4 | | | | | | |
| | | Water- | | | | |
| | | immersion | | | | |
| | Pretreatment | pH | | | | |
| Ex. #8 | Being Immersed in pH = 2 Nitric | 4.4 | 2.2 | 2.2 | 225 | 1.4 |
| | Acid Aqueous Solution for 2 | | | | | |
| | hours | | | | | |
| Ex. #9 | Being Immersed in pH = 2 Acetic | 5.3 | 2.2 | 3.1 | 226 | 1.4 |
| | Acid Aqueous Solution for 2 | | | | | |
| | hours | | | | | |
| Ex. #10 | Being Immersed in pH = 2 | 4.3 | 2.2 | 2.1 | 236 | 1.6 |
| | Hydrochloric Acid Aqueous | | | | | |
| | Solution for 2 hours | | | | | |
| Ex. #11 | Distributing CO₂-contaiing | 6.0 | 2.2 | 3.8 | 224 | 1.3 |
| | Gas for 5 hours | | | | | |
| Ex. #12 | Distributing CO₂-containing | 6.0 | 3.4 | 2.6 | 221 | 1.1 |
| | Gas for 5 hours | | | | | |
| Comp. | Being Immersed in pH = 10 | 8.8 | 2.2 | 6.6 | 278 | 3.2 |
| Ex. #5 | Ammonia Water for 2 hours | | | | | |

1. A catalyst for purifying exhaust gases, the catalyst comprising:
an oxide powder having a characteristic that a suspension suspending the oxide powder exhibits a pH value of 7 or less; and
a noble metal loaded on the oxide powder by using a noble metal salt solution exhibiting a pH value lower than the pH value of the suspension suspending the oxide powder in pure water.

2. The catalyst for purifying exhaust gases set forth in claim 1, wherein said oxide powder is a CeO₂-based oxide including CeO₂ at least.

3. The catalyst for purifying exhaust gases set forth in claim 2, wherein said oxide powder includes at least one element selected from the group consisting of Zr, La, Y and Nd.

4. The catalyst for purifying exhaust gases set forth in claim 1, wherein said noble metal salt solution is a Pt salt aqueous solution.

5. The catalyst for purifying exhaust gases set forth in claim 1, wherein a difference (ΔpH) between said pH value of the suspension suspending the oxide powder in pure water and said pH value of the noble metal salt solution is from 1 to 5.

6. A process for producing a catalyst for purifying exhaust gases, the process comprising the steps of:
preparing an oxide powder having a characteristic that a suspension suspending the oxide powder in pure water exhibits a pH value of 7 or less; and
loading a noble metal on the oxide powder by using a noble metal salt solution exhibiting a pH value lower than the pH value of the suspension suspending the oxide powder in pure water.

7. The process for producing a catalyst for purifying exhaust gases set forth in claim 6, wherein said oxide powder is a CeO₂-based oxide including CeO₂ at least.

8. The process for producing a catalyst for purifying exhaust gases set forth in claim 7, wherein said oxide powder further includes at least one element selected from the group consisting of Zr, La, Y and Nd.

9. The process for producing a catalyst for purifying exhaust gases set forth in claim 6, wherein said noble metal salt solution is a Pt salt aqueous solution.

10. The process for producing a catalyst for purifying exhaust gases set forth in claim 6, wherein a difference (ΔpH) between said pH value of the suspension suspending the oxide powder in pure water and said pH value of the noble metal salt solution is from 1 to 5.
